(19) United States
(12) Patent Application Publication
(10) Pub. No.: US 2018/0176385 A1
(43) Pub. Date: Jun. 21, 2018

(54) SUPPLEMENTING TELEPHONY CALLS WITH CONVERSATIONAL BOTS

(71) Applicant: Microsoft Technology Licensing, LLC, Redmond, WA (US)

(72) Inventors: Amritansh Raghav, Seattle, WA (US); Ivo Manolov, Redmond, WA (US); Farookh Mohammed, Woodinville, WA (US)

(21) Appl. No.: 15/387,379

(22) Filed: Dec. 21, 2016

(51) Int. Cl. H04M 7/00; H04M 3/42; H04L 12/58

(52) U.S. Cl. CPC H04M 7/0033; H04M 7/0045; H04L 51/02; H04M 3/4211

(57) ABSTRACT

Systems, methods, and software technology for providing enhanced telephony experiences. In an implementation, a calling party may place a call to a called party. A communication service receives a call request from a client application associated with the calling party requesting that the call be initiated to the called party. The communication service responsively connects the calling party to the called party, but also associates a conversational bot with the call. During the call, the communication service identifies supplemental information associated with the called party to send to the client application by way of the conversational bot. The calling party may thus consume the supplemental information and engage with the conversational bot during the call.

### TECHNICAL BACKGROUND

Artificial conversational entities, or conversation bots, are computer programs that engage with end users in conversations. A messaging bot is one type of conversation bot that converses with end users through text messaging, for example.

Conversational bots have proliferated in recent times and are becoming common features of the communication landscape, serving in a variety of operational circumstances and situations. For example, airlines may utilize customer service bots to provide customer service to end users through their text messaging applications, in lieu of phone calls. Retail organizations may utilize shopping bots to assist users with searching for and purchasing goods and services.

In most of these cases, the use of a bot relieves the end user of having to reach a party through a dedicated website or application. Rather, the end user can simply converse with a commercial entity's conversational bot using a messaging application or other such general purpose communication tools.

While relatively popular with end users, hosting a conversational bot requires a great deal of investment and infrastructure that many organizations may be hesitant to deploy. A small business, for example, may lack the institutional knowledge, capabilities, or resources required to design, build, test, and deploy a conversational bot to converse with customers on behalf of the organization. When organizations refrain from deploying conversational bots, the public is left without the convenience of engaging with the organization through the new communication channel.

From a more technical perspective, end users will continue to reach organizations through less convenient channels, potentially wasting their time and effort, as well as communication and processing resources. For example, a user may manually query a search engine using their mobile phone to determine the operating hours of a small business. While seemingly miniscule, such operations in the aggregate can consume a great deal of bandwidth, battery power, and other device and network resources.

### Overview

Communications technology is disclosed herein that supplements telephony calls (e.g. voice and video calls) with conversational bots. The presence of a conversational bot during a call may alleviate the need for manual searches or additional phone calls, thereby conserving time and effort, as well as device and network resources.

In an implementation, a calling party may place a call to a called party. A communication service receives a call request from a client application associated with the calling party requesting that the call be initiated to the called party. The communication service responsively connects the calling party to the called party, but also associates a conversational bot with the call. During the call, the communication service identifies supplemental information associated with the called party to send to the client application by way of the conversational bot. The calling party may thus consume the supplemental information and engage with the conversational bot during the call.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational environment in an implementation.

FIG. 2 illustrates a call handling process in an implementation.

FIG. 3 illustrates an operational sequence in an implementation.

FIG. 4 illustrates an operational scenario in an implementation.

FIG. 5 illustrates an operational scenario in an implementation.

FIG. 6 illustrates a computing system suitable for implementing the communications technology disclosed herein, including any of the architectures, elements, processes, and operational scenarios and sequences illustrated in the Figures and discussed below in the Technical Disclosure.

### TECHNICAL DISCLOSURE

Communications technology is disclosed herein that allows telephony calls to be supplemented with conversational bots in an ad-hoc manner and without called parties having to develop, manage, or otherwise host a conversational bot.

In an implementation, when a calling party attempts to reach a called party, a communication service handling the call associates a conversational bot with the call. As the call is being connected, the communication service obtains information about the called party with which to supplement the call. The conversational bot associated with the call may communicate the supplemental information to the calling party. This may take the form of, for example, surfacing a message from the bot in a user interface to a client application used by the calling party to make the call.

In some implementations, it may be the case that the communication service (or some entity other than the called party) hosts the conversational bot. A call to the called party may thus result in a connection to the called party, but also a connection to the conversational bot in its hosted environment. The call connection and the bot connection may overlap for at least some amount of time. This may be especially so when the calling party continues parallel conversations with both the called party and the conversational bot.

The conversational bot may be added to a contact for the called party in the contacts of the calling party, if so desired by the user. The conversational bot may thus become a new way (modality) for the user to obtain information about the called party at any given time. Subsequent to having added the bot as a contact modality for the previously-called party, the user can engage with the conversational both through the contact to make inquiries about the called party, rather than calling the called party. For example, the user may inquire with the conversational bot about the hours of operation of a business, rather than calling the business itself. This provides the technical advantage of increased convenience for the user without the business having to expend the resources necessary to develop, manage, and host a conversational bot.

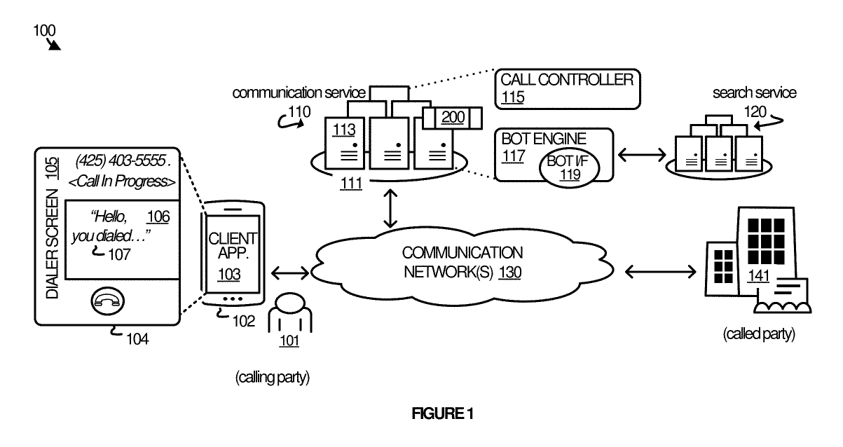

FIG. 1 illustrates operational environment 100 in an implementation. Operational environment 100 includes communication device 102, communication service 110, search service 120, and communication network 130. A calling party 101 may utilize a client application 103 on communication device 102 to play voice and/or video telephony calls over a network or networks to called parties, of which called party 151 is representative.

Client application 103 is representative of any communication application that may be implemented on a mobile phone, tablet, laptop, or desktop computer, or any other suitable computing device, of which communication device 102 is representative. Client application 103 may be integrated in the context of a larger communication application or may be implemented as a stand-alone application. Examples of client application 103 include, but are not limited to, Skype® and Skype for Business®.

Communication service 110 is representative of an online service capable of providing call origination and termination services for telephony calls. Other services may also be provided by communication service 110, such as instant messaging services. Skype®, Skype for Business®, Facetime®, and Google Hangouts® are just some examples of communication service 110.

Communication service 110 may be implemented in one or more data centers, of which data center 111 is representative. Data center 111 may include an array hardware and/or software resources 113 suitable for hosting one or more services, such as server computers, routers, switches, firewalls, virtual machines, containers, and any other type of physical or virtual computing resource and combinations thereof.

A call controller 115 is one example of a resource that may be deployed in data center 111 to facilitate phone calls. Call controller 115 is representative of a processing element capable of handling incoming and outgoing call requests to originate and terminate voice or video phone calls. Call controller 115 may be a standalone processing element or may be implemented in the context of a larger call processing service.

Bot engine 117 is another example of a resource that may be deployed in data center 111. Bot engine 117 is representative of software resource capable of implementing a conversational bot. Bot engine 117 includes a bot interface 119 for communicating with end-users via their client applications. To drive the bot experience, bot engine 117 may employ operational logic and conversational logic implemented in software. Bot engine 117 may also access external resources, such as natural language processing platforms, but also external search services, represented by search service 120.

Search service 120 is representative of a search engine platform that may be queried by bot engine 117 to retrieve information relevant to a search query. Examples of search service 120 include, but are not limited to, Bing®, Google®, and Yahoo®. Search service 120 may be externally or internally with respect to communication service 110.

Communication network 130 is representative of one or more networks that may carry communications to and from communication device 102, data center 111, and called party 141. Examples include, but are not limited to, wireless and wireline networks, local area networks (LANs) and wide area networks (WANs), internets and intranets, the Internet, Voice Over Internet Protocol (VoIP) networks, cable or fiber optic networks, and the public switched telephone network (PSTN), as well as any type or combination of networks.

Called party 141 is representative of any individual or organization to which a phone call may be placed. Suitable equipment may be present for receiving calls, such as a telephone, mobile phone, or soft phone. Called party 141 may be reached by a phone number, a service handle, an alias, or some other identifier. Called party 141 may be, for example, a business, a governmental entity, a charitable organization, an educational institution, or the like.

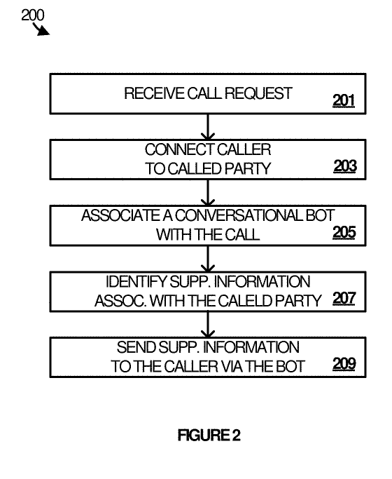

FIG. 2 illustrates a call handling process 200 employed by communication service 110 in the context of connecting the call to a called party. Call handling process 200 may be implemented in program instructions in the context of any of the software applications, modules, components, or other such programming elements that comprise a given communication service. The program instructions direct the underlying physical or virtual computing system or systems that provide the communication service to operate as follows.

Referring parenthetically to the steps illustrated in FIG. 2, a communication service under the control of call handling process 200 receives a call request from a calling party to a called party (step 201). The communication service connects the calling party to the called party (203), but also proceeds to associate a conversational bot with the call (step 205). A specific conversational bot may already exist that can be associated with the call. In other situations, a new conversational bot may be generated that may then be associated with the call.

In addition to associating a bot with the call, the communication service also identifies supplemental information to associate with the called party (step 207). This may involve querying a search service (e.g. Bing®) for information on the called party. The search query may include the called number, an identity of the called party, or both. The search query may be of a general type or it may adhere to a specific type of query directed to a specific capability of the search service.

The search service returns search results, at least some of which the communication service may send to the calling party through the conversational bot (step 209). The supplemental information may be expressed through a user interface rendered by the device used by the calling party, such as a messaging interface. In some implementations, the messaging interface may be surfaced in the user interface to a telephone application (e.g. Skype® and Skype for Business®) being used by the calling party during the call. Thus, the calling party may consume the supplemental information surfaced by the conversational bot while on the call with the called party.

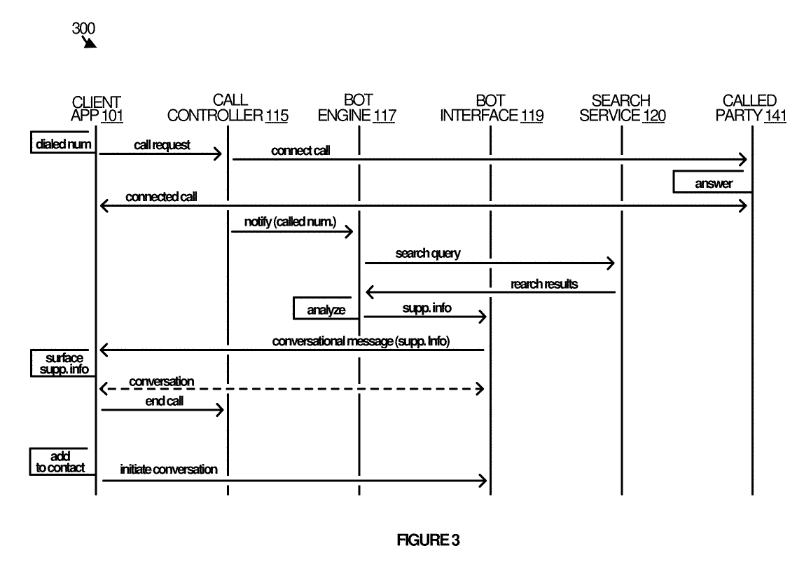

FIG. 3 illustrates an operational scenario 300 involving operational environment 100. In operational scenario 300, caller 101 may use client application 103 on communication device 102 to place voice or video phone calls to called parties. The caller 101 may select a contact from his or her contacts, dial a phone number, or otherwise start the phone call. The client application 103 interfaces with communication service 110 in order to originate the phone call. Client application 103 may send a call request to communication service 110 over communication network 130.

Call controller 115 in communication service 110 receives the call request and connects caller 101 to called party 141. Depending upon how the called party is reached, this may involve terminating the call within communication service 110 (e.g. when the called party is another subscriber to communication service 110). However, this may also include interfacing with another communication service 110 to receive the call, transiting other networks, and so on. As an example, the call may need to be connected through a gateway to a circuit switched telephone network or to another Voice over Internet Protocol (VoIP) network, or both. Assuming the call is answered, a bi-directional connection may be established to allow caller 101 and called party 141 to converse.

During the call, call controller 115 notifies bot engine 117 of the call, so that a conversational bot may be associated with it. This may occur, for example, while the called party 141 is ringing or after the called party has answered. Call controller 115 may provide bot engine 117 with the called number, an identity of the called party, or some other identifying information that bot engine 117 may use to obtain supplemental information. In situations where call controller 115 only provides bot engine 117 with the called number, bot engine 117 may perform a preliminary search to identify the party associated with the called number (e.g. an individual, a business, or an organization). In other cases, call controller 115 may perform the preliminary search to identify the party associated with the called number.

Having identified the called party itself or from call controller 115, bot engine 117 queries search service 120 with the identifying information and receives search results in reply. The search results can be analyzed for a subset that may be provided as the supplemental information. As an example, the search results may indicate the name of a business, its hours of operation, its address, and possible other helpful details about the business. Bot engine 117 formulates a conversational message that includes the supplemental information and communicates the message to client application 103.

Client application 103 receives the message and surfaces it in a user interface to the application. In some scenarios, the conversational message is surfaced in whichever screen of the application is active at the time. For instance, the conversational message can be surfaced in the dialer screen that is active while a call is ongoing. Calling party 101 may reply to the message and may in fact engage in a conversation with the bot engine 117 through the bot interface 119. The calling party 101 may ask for additional details about the business, for example, such as menu offerings, prices, and the like. The calling party 101 may converse with the bot while the call with the called party 141 is ongoing.

At some point, the call may end when one or the other party hangs up. Optionally, the caller may add the conversational bot as a contact mode within a contact for the calling party in the caller's contacts. This would allow the caller to engage with the conversational bot at a subsequent time in order to obtain information about the business associated with the called number. For instance, the caller may at a later date or time inquire with the bot about the business's hours of operation, menu offerings, or other such operational details, without having to place a call.

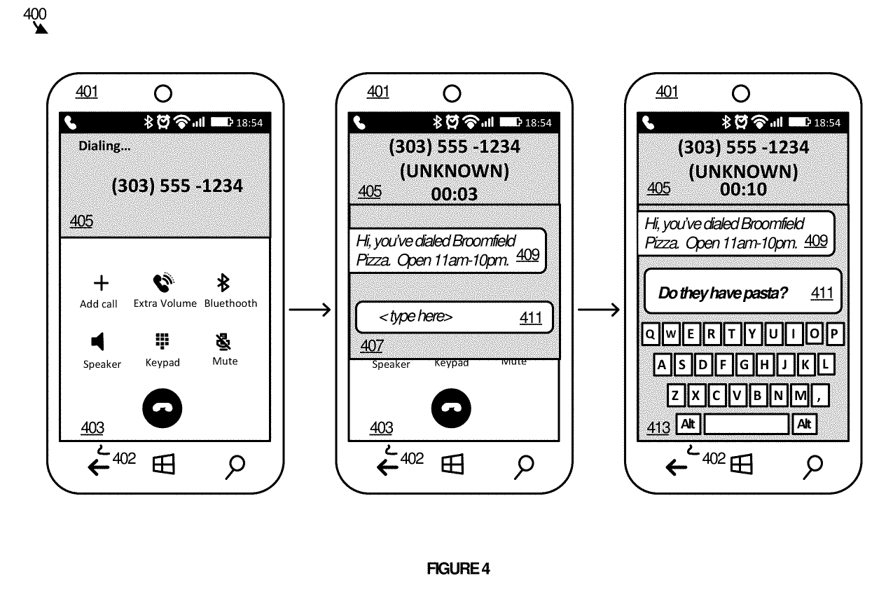

FIG. 4 illustrates another operational scenario 400 in an implementation. In operational scenario 400, communication device 401 is representative of a device that a user may use to place a voice or video call. Communication device 401 includes a display on which a user interface 402 to an application may be displayed. The application may be, for example, a client application that provides connectivity to a communication service.

In this scenario, a user has dialed a phone number (303-555-1234) in order to place a call to a called party. The user interface 402 includes various controls in a dialer screen for interfacing with capabilities of the client application, the device, or other aspects related to the call. For example, the user may control the volume of the call, bring up a keypad, switch the call to a blue tooth device, add a call, or hang up the call. A status window 405 is also provided in the user interface 402 that shows the status of the call. At the outset of the scenario, the dialed number is being called.

In the background, the communication service through which the client applications is placing the call is employing call handling process 200 to supplement the call with a conversational bot. Before or after the call transitions to a connected state, the user interface 402 is supplemented with a messaging interface 407 surfaced over the dialer screen 403. The status window 405 shows the call as ongoing, while a message 409 from the conversational bot is surfaced in the messaging interface 407. An input box 411 is provided for entering a reply to the conversational bot.

The message from the conversational bot indicated the nature of the business that was called and some basic details about its hours of operation. The user in this example replies with a question about its menu, supplied through input box 411. A soft keyboard 413 is rendered in user interface 402 for receiving the user's touch input, although other types of input are possible, such as voice input, keyboard input, or the like.

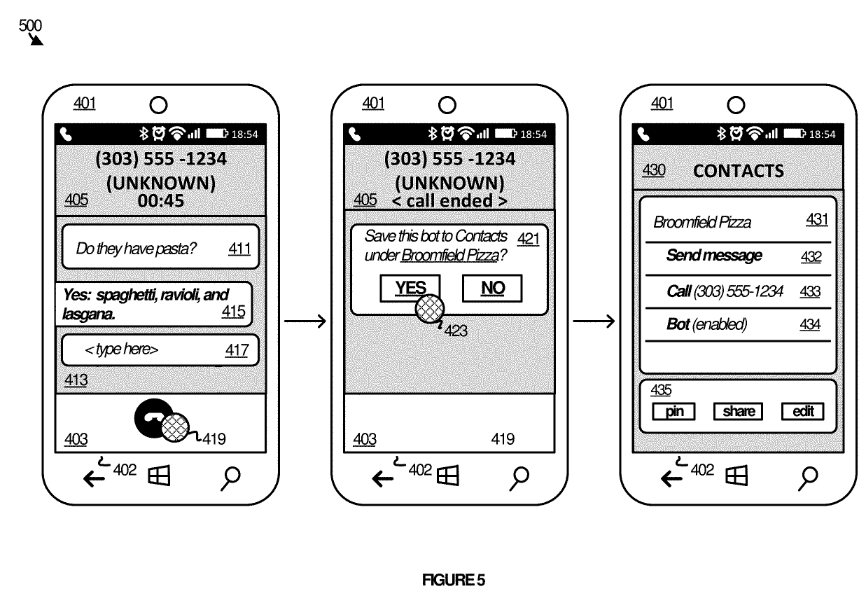

FIG. 5 illustrates operational scenario 500, which may be a continuation of operational scenario 400 in FIG. 4. In FIG. 5, the conversational bot has replied with a message 415 describing some menu items. An input box 417 is available for the user to continue to converse with the conversational bot, all while on the call.

Eventually, the user may supply a user input 419 to end the call. The user input may be a touch, a spoken command, or some other suitable input. Hanging up the call changes the status of the call displayed in status window 405 to “call ended.” At that time, a prompt 421 may be surface in the user interface 402 asking the user if he or she would like to save the conversational bot under a contact in their contacts for the business. If the user provides a user input 423 to select “yes,” then a new contact mode is created under a contact in the user's contacts 430 for the business. Other features 435 may also be available in association with the contact, such as a pin feature, a share feature, and an edit feature.

The business may be identified by a contact name 431 and various contact modes may be included under the contact, such as a messaging mode 432, a calling mode 433, and now a conversational bot mode 434. In other words, the user may now engage with the conversational bot associated with the business by navigating to the contact for the business in the user's contacts. This may be the case, even if the conversational bot is neither hosted nor sponsored by the business. Rather, the conversational bot is an “ad-hoc” bot created for the user to engage with the user on a call. The user can engage again with the conversational bot any time the user desires to inquire about the business.

The conversational bot may be reached subsequent to the phone call in a variety of different ways. In one implementation, a communication service (e.g. 110) may supply the client application with a specific identifier for the conversational bot, such as a unique telephone number or a unique service handle that the client application can use to converse with the bot. The identifier may then be stored under the contact for the business so that, when the bot mode is selected from the contact for the business, messages can be sent using the stored identifier.

The conversational bot—and thus its identifier—may be unique to the caller in that only the caller can reach that specific instance of a bot. The conversational bot may be personalized in a sense, in that it is created for the user and is reached through an identifier unique to the user. A similar bot for the same business but a different end-user would be named differently, even though both bots related to the same business or organization.

In a different implementation, a single conversational bot may be “re-used” in that, once created, it may serve and converse with multiple end-users or callers. In such a situation, the identifier used to converse with the bot would be unique to the business, but not unique to any given end-user. One end-user could use the same identifier to converse with the conversational bot as another end-user.

In any case, in order to save the conversational bot under a contact for a called party, the client application may draw an identifier (e.g. phone number or service handle) from the messages received from the conversational bot during the phone call. The act of saving the conversational bot's contact information to a contact for the called party may trigger the client application to notify the communication service of the event. Such a notification would serve to inform the communication service that the user may desire to converse with the conversational bot again at a later date or time. In response, the communication service may maintain some contextual awareness of the previous conversation in order to enhance the quality of any future conversation between the end-user and the conversational bot.

By storing the conversational bot as a contact mode, the end-user is able to make inquires of a general type that our understood by the conversational bot as pertaining to the contact under which the bot is stored. For instance, the end-user may navigate to a contact in his or her contacts for a particular restaurant. Selecting the conversational bot modality, the end-user may type a brief string inquiring whether or not the restaurant is open. The conversational bot will receive the message and will know that the question pertains to the business, as opposed to being an open-ended (and unanswerable) question pertaining to any business. The conversational bot can perform a search to arrive and the answer and may reply to the end-user with the same. In contrast, without access to the conversational bot, the end-user would have to produce a more specific query to submit to a search engine.

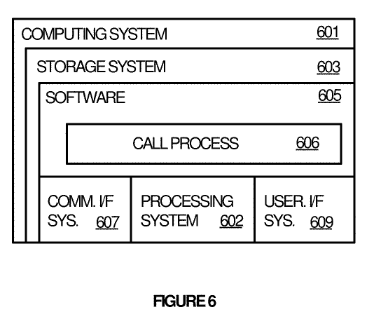

FIG. 6 illustrates computing system 601, which is representative of any system or collection of systems in which the various applications, services, scenarios, and processes disclosed herein may be implemented. Examples of computing system 601 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 601 may be implemented as a single apparatus, system, or device or may be implemented in a distributed manner as multiple apparatuses, systems, or devices. Computing system 601 includes, but is not limited to, processing system 602, storage system 603, software 605, communication interface system 607, and user interface system 609. Processing system 602 is operatively coupled with storage system 603, communication interface system 607, and user interface system 609.

Processing system 602 loads and executes software 605 from storage system 603. Software 605 includes call handling process 606, which is representative of the processes discussed with respect to the preceding FIGS. 1-5, including call handling process 200. When executed by processing system 602 to supplement calls with conversational bots, software 605 directs processing system 602 to operate as described herein for at least the various processes, operational scenarios, and sequences discussed in the foregoing implementations. Computing system 601 may optionally include additional devices, features, or functionality not discussed for purposes of brevity.

Referring still to FIG. 6, processing system 602 may comprise a micro-processor and other circuitry that retrieves and executes software 605 from storage system 603. Processing system 602 may be implemented within a single processing device, but may also be distributed across multiple processing devices or sub-systems that cooperate in executing program instructions. Examples of processing system 602 include general purpose central processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or other suitable storage media, except for propagated signals. In no case is the computer readable storage media a propagated signal.

In addition to computer readable storage media, in some implementations storage system 603 may also include computer readable communication media over which at least some of software 605 may be communicated internally or externally Storage system 603 may be implemented as a single storage device, but may also be implemented across multiple storage devices or sub-systems co-located or distributed relative to each other. Storage system 603 may comprise additional elements, such as a controller, capable of communicating with processing system 602 or possibly other systems.

Software 605 may be implemented in program instructions and among other functions may, when executed by processing system 602, direct processing system 602 to operate as described with respect to the various operational scenarios, sequences, and processes illustrated herein. For example, software 605 may include program instructions for implementing call handling process 200.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtual machine software, or other application software, in addition to or that include call handling process 606. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to supplement calls with conversational bots. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 609 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 609. In some cases, the input and output devices may be combined in a single device, such as a display capable of displaying images and receiving touch gestures. The aforementioned user input and output devices are well known in the art and need not be discussed at length here.

User interface system 609 may also include associated user interface software executable by processing system 602 in support of the various user input and output devices discussed above. Separately or in conjunction with each other and other hardware and software elements, the user interface software and user interface devices may support a graphical user interface, a natural user interface, or any other type of user interface.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

Certain inventive aspects may be appreciated from the foregoing disclosure, of which the following are various examples.

Example 1. A method of operating a communication service to supplement telephony calls with conversational bots, the method comprising: receiving a request from a communication application associated with a calling party to initiate a call between the calling party and a called party; in response to the request, connecting the calling party to the called party and associating a conversational bot with the call; and during the call between the calling party and the called party, identifying supplemental information associated with the called party and sending the supplemental information to the communication application through the conversational bot.

Example 2. The method of Example 1 wherein the request includes a called number and wherein the method further comprises searching through a plurality of conversational bots for one conversational both associated with the called number.

Example 3. The method of Examples 1-2 wherein associating the conversational bot with the call comprises associating the one conversational bot with the call and, if no match for the called number is found, generating a new conversational bot to associate with the called number.

Example 4. The method of Examples 1-3 further comprising surfacing the supplemental information through a dialer screen in a user interface to the communication application during the call.

Example 5. The method of Examples 1-4 wherein identifying the supplemental information comprises querying a search service for information on the called party.

Example 6. The method of Examples 1-5 further comprising exchanging conversational communications between the conversational bot and the calling party during the call between the calling party and the called party.

Example 7. The method of Examples 1-6 further comprising adding the conversational bot as a new contact modality for a contact associated with the called party in the calling party's contacts.

Example 8. A computing apparatus comprising: one or more computer readable storage media; a processing system operatively coupled to the one or more computer readable storage media; and program instructions store on the one or more computer readable storage media for supplementing telephony calls with conversational bots that, when executed by the processing system, direct the processing system to at least: in response to a request from a communication application associated with a calling party to initiate a call between the calling party and a called party connect the calling party to the called party and associate a conversational bot with the call; and during the call between the calling party and the called party, identify supplemental information associated with the called party and send the supplemental information to the communication application through the conversational bot.

Example 9. The computing apparatus of Example 8 wherein the request includes a called number and wherein the program instructions further direct the processing system to search through a plurality of conversational bots for one conversational bot associated with the called number.

Example 10. The computing apparatus of Examples 8-9 wherein the program instructions, to associate the conversational bot with the call, direct the processing system to associate the one conversational bot with the call and, if no match for the called number is found, generate a new conversational bot to associate with the called number.

Example 11. The computing apparatus of Examples 8-10 wherein the program instructions further direct the processing system to surface the supplemental information through a dialer screen in a user interface to the communication application during the call.

Example 12. The computing apparatus of Examples 8-11 wherein to identify the supplemental information, the program instructions direct the processing system to query a search service for information on the called party.

Example 13. The computing apparatus of Examples 8-12 wherein the program instructions further direct the processing system to exchange conversational communications between the conversational bot and the calling party during the call.

Example 14. The computing apparatus of Examples 8-13 wherein the program instructions further direct the processing system to add the conversational bot as a new contact modality for a contact associated with the called party in the calling party's contacts.

Example 15. A computing apparatus comprising: one or more computer readable storage media; a processing system operatively coupled to the one or more computer readable storage media; and a communication application comprising program instructions store on the one or more computer readable storage media that, when executed by the processing system, direct the processing system to at least: render a dialer screen in a user interface to the communication application; receive a dialed number through the dialer screen and responsively place a call to a called party associated with the dialed number; and during the call, receive supplemental information from a conversational bot associated with the call and surface the supplemental information in the user interface.

Example 16. The computing apparatus of Example 15 wherein to surface the supplemental information in the user interface, the program instructions direct the processing system to surface the supplemental information in the dialer screen.

Example 17. The computing apparatus of Examples 15-16 wherein the program instructions further direct the processing system to exchange communications with the conversational bot during the call with the called party.

Example 18. The computing apparatus of Examples 15-17 wherein the program instructions further direct the processing system to surface a prompt in the user interface to add the conversational bot to a set of contacts.

Example 19. The computing apparatus of Examples 15-18 wherein, to add the conversational bot to a set of contacts, the program instructions further direct the processing system to add the conversational bot as a contact modality under a contact associated with the called party.

Example 20. The computing apparatus of Examples 15-19 wherein the contact associated with the called party comprises a plurality of contact modalities including a telephony modality and a conversational bot modality.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A method of operating a communication service to supplement telephony calls with conversational bots, the method comprising:
receiving, via a call controller, a request from a communication application associated with a calling party to initiate a call between the calling party and a called party;
in response to the request, connecting the calling party to the called party via the call controller and associating a conversational bot with the call;
during the call between the calling party and the called party, querying a search service through the conversational bot for supplemental information associated with the called party;
analyzing search results received from the search service for a subset to provide as the supplemental information associated with the called party; and
sending the supplemental information to the communication application through the conversational bot.

2. The method of claim 1 wherein the request includes a called number and wherein the method further comprises searching through a plurality of conversational bots for one conversational bot associated with the called number.

3. The method of claim 2 wherein associating the conversational bot with the call comprises associating the one conversational bot with the call and, if no match for the called number is found, generating a new conversational bot to associate with the called number.

4. The method of claim 1 further comprising surfacing the supplemental information through a dialer screen in a user interface to the communication application during the call.

5. The method of claim 1 further comprising, after the call between the calling party and the called party is disconnected, engaging the conversational bot with the caller absent call controller interaction.

6. The method of claim 1 further comprising exchanging conversational communications between the conversational bot and the calling party during the call between the calling party and the called party.

7. The method of claim 1 further comprising adding the conversational bot as a new contact modality for a contact associated with the called party in the calling party's contacts.

8. A computing apparatus comprising:
one or more computer readable storage media;
a processing system operatively coupled to the one or more computer readable storage media; and
program instructions stored on the one or more computer readable storage media for supplementing telephony calls with conversational bots that, when executed by the processing system, direct the processing system to at least:
in response to a request from a communication application associated with a calling party to initiate a call between the calling party and a called party wherein the request includes a called number:
connect the calling party to the called party;
search through a plurality of conversational bots for one conversational bot to associate with the called number; and
associate the one conversational bot with the call; and
during the call between the calling party and the called party, query a search service through the conversational bot for supplemental information associated with the called party;
analyze search results received from the search service for a subset to provide as the supplemental information associated with the called party; and
send the supplemental information to the communication application through the one conversational bot.

9. (canceled)

10. The computing apparatus of claim 8 wherein the program instructions, to associate the one conversational bot with the call, direct the processing system to associate the one conversational bot with the call and, if no match for the called number is found, generate a new conversational bot to associate with the called number.

11. The computing apparatus of claim 8 wherein the program instructions further direct the processing system to surface the supplemental information through a dialer screen in a user interface to the communication application during the call.

12. The computing apparatus of claim 8 wherein the program instructions further direct the processing system to, after the call between the calling party and the called party is disconnected, engage the conversational bot with the caller absent another request to initiate the call between the calling party and the called party.

13. The computing apparatus of claim 8 wherein the program instructions further direct the processing system to exchange conversational communications between the one conversational bot and the calling party during the call.

14. The computing apparatus of claim 8 wherein the program instructions further direct the processing system to add the one conversational bot as a new contact modality for a contact associated with the called party in the calling party's contacts.

15. A computing apparatus comprising:
one or more non-transitory computer readable storage media;
a processing system operatively coupled to the one or more non-transitory computer readable storage media; and
a communication application comprising program instructions stored on the one or more non-transitory computer readable storage media that, when executed by the processing system, direct the processing system to at least:
render a dialer screen in a user interface to the communication application;
receive a dialed number through the dialer screen and responsively place a call, via communication with a call controller, to a called party associated with the dialed number;
during the call, query a search service through a conversational bot for supplemental information associated with the called party;
analyze search results received from the search service for a subset to provide as the supplemental information associated with the called party; and
surface the supplemental information in the user interface.

16. The computing apparatus of claim 15 wherein to surface the supplemental information in the user interface, the program instructions direct the processing system to surface the supplemental information in the dialer screen.

17. The computing apparatus of claim 15 wherein the program instructions further direct the processing system to exchange communications with the conversational bot during the call with the called party.

18. The computing apparatus of claim 15 wherein the program instructions further direct the processing system to surface a prompt in the user interface to add the conversational bot to a set of contacts.

19. The computing apparatus of claim 18 wherein, to add the conversational bot to a set of contacts, the program instructions further direct the processing system to add the conversational bot as a contact modality under a contact associated with the called party.

20. The computing apparatus of claim 19 wherein the contact associated with the called party comprises a plurality of contact modalities including a telephony modality and a conversational bot modality.
